(19) United States
(12) Patent Application Publication
(10) Pub. No.: US 2015/0185807 A1
(43) Pub. Date: Jul. 2, 2015

(54) INFORMATION PROCESSING APPARATUS, METHOD FOR CONTROLLING INFORMATION PROCESSING APPARATUS, PROGRAM, AND RECORDING MEDIUM

(71) Applicant: CANON KABUSHIKI KAISHA, Tokyo (JP)

(72) Inventor: Ryotaro Okuzono, Kawasaki-shi (JP)

(21) Appl. No.: 14/581,641

(22) Filed: Dec. 23, 2014

(30) Foreign Application Priority Data
Dec. 27, 2013 (JP) 2013-272038

(51) Int. Cl. G06F 1/32

(52) U.S. Cl. CPC G06F 1/3231; G06F 1/3234

(57) ABSTRACT

An information processing apparatus capable of communicating with an external device includes a receiving unit configured to receive from the external device a shutdown instruction for shutting down the information processing apparatus, a detection unit configured to detect a person being present near the information processing apparatus, and a control unit configured to restrict shutdown of the information processing apparatus according to the shutdown instruction received by the receiving unit while the detection unit is detecting presence of a person near the information processing apparatus.

### BACKGROUND OF THE INVENTION

1. Field of the Invention

One disclosed aspect of the embodiments relates to an information processing apparatus that performs power control according to a request transmitted from a terminal connected thereto via a network, a method for controlling the information processing apparatus, a program, and a recording medium.

2. Description of the Related Art

There has been conventionally known a technique for remotely controlling the power of an information processing apparatus being a target of power control from a terminal connected thereto (Japanese Patent Application Laid-Open No. 2010-152709).

The image forming apparatus discussed in Japanese Patent Application Laid-Open No. 2010-152709 switches to a power off state when a power off request packet transmitted from a terminal is received. However, when switching an image forming apparatus to the power off state via a network from a terminal that is physically distant from that image forming apparatus, the situation around the image forming apparatus is unknown from that terminal. Consequently, the image forming apparatus that has received the power off request packet may switch to the power off state despite an object such as a person being present near the image forming apparatus. In other words, in Japanese Patent Application Laid-Open No. 2010-152709, the image forming apparatus that has received the power off request packet may switch to the power off state despite there being a person near the image forming apparatus. From the perspective of a user, the power is suddenly switched off even though the user is about to use the image forming apparatus. Thus, when remotely controlling the power supply of an image forming apparatus, user convenience may be harmed.

### SUMMARY OF THE INVENTION

One disclosed aspect of the embodiments is directed to controlling the power of an information processing apparatus via a network when a person is present near the apparatus.

According to an aspect of the embodiments, an information processing apparatus capable of communicating with an external device includes a detection unit configured to detect a person being present near the information processing apparatus, a transmission unit configured to, if the detection unit detects a person near the information processing apparatus, transmit a screen for selecting on the external device whether to forcibly shut down the information processing apparatus or to wait shutdown of the information processing apparatus, and a control unit configured to shut down the information processing apparatus if an instruction for forcibly shutting down the information processing apparatus has been issued on the screen displayed on the external device, and if an instruction for waiting shutdown of the information processing apparatus has been issued on the screen displayed on the external device, to restrict the shutdown until the detection unit no longer detects a person near the information processing apparatus.

According to another aspect of the embodiments, an information processing apparatus capable of communicating with an external device includes a receiving unit configured to receive from the external device a shutdown instruction for shutting down the information processing apparatus, a detection unit configured to detect a person being present near the information processing apparatus, and a control unit configured to restrict shutdown of the information processing apparatus according to the shutdown instruction received by the receiving unit while the detection unit is detecting presence of a person near the information processing apparatus.

Further features of the disclosure will become apparent from the following description of exemplary embodiments with reference to the attached drawings.

### BRIEF DESCRIPTION OF THE DRAWINGS

FIG. 1 illustrates an overall configuration of a printing system that includes an image forming apparatus according to a first exemplary embodiment.

FIG. 2 is a plan view of the image forming apparatus.

FIG. 3 is a hardware block diagram of the image forming apparatus.

FIG. 4 is a block diagram of a sensor unit.

FIG. 5 is a power supply circuit diagram of the image forming apparatus.

FIG. 6 is a power supply circuit diagram of the image forming apparatus in a standby state.

FIG. 7 is a power supply circuit diagram of the image forming apparatus in a sleep state.

FIG. 8 is a power supply circuit diagram of the image forming apparatus in a power off state.

FIG. 9 is a diagram illustrating processing that is executed between a PC and the image forming apparatus when remotely shutting down the image forming apparatus from the PC.

FIGS. 10A, 10B, 10C, and 10D each illustrate a screen displayed on a PC.

FIG. 11 is a flowchart illustrating processing executed by the image forming apparatus that has received a shutdown request.

FIG. 12 is a flowchart illustrating processing executed by the image forming apparatus that has received a shutdown instruction.

FIGS. 13A and 13B each illustrate a screen displayed on a display unit of the image forming apparatus.

FIG. 14 is a flowchart illustrating processing executed by an image forming apparatus that has received a shutdown request, according to a second exemplary embodiment.

FIGS. 15A-1, 15A-2, 15B-1 and 15B-2 illustrate algorithms for detecting a person approaching an image forming apparatus.

### DESCRIPTION OF THE EMBODIMENTS

Various exemplary embodiments, features, and aspects of the disclosure will be described in detail below with reference to the drawings.

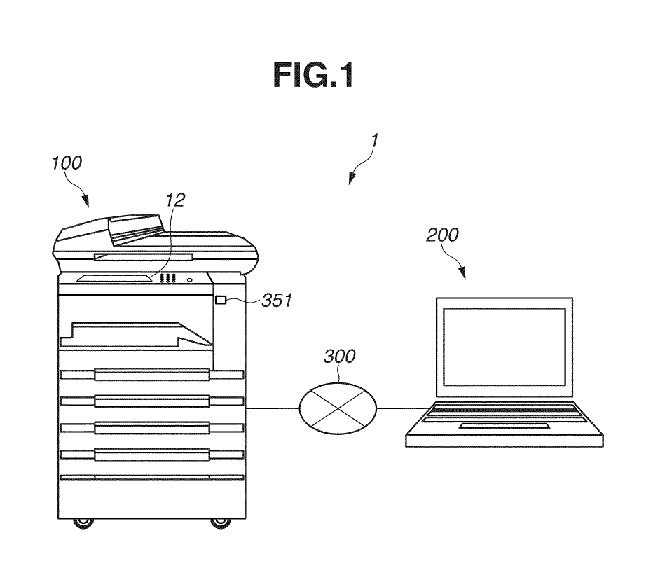

FIG. 1 illustrates an overall configuration of a printing system that includes an image forming apparatus according to a first exemplary embodiment.

As illustrated in FIG. 1, a printing system 1 includes an image forming apparatus 100 and a personal computer (PC) 200, which is an external device. In the printing system 1, the image forming apparatus 100 and the PC 200 are connected via a network 300 so that communication can be performed therebetween. This network 300 may be a wired network, or may be a wireless network. An infrared array sensor 351 is attached to a front face of the image forming apparatus 100.

The PC 200, which includes a central processing unit (CPU), a random-access memory (RAM), and a fixed storage device such as a hard disk drive (HDD), is a common computer device to which a monitor, a keyboard, a mouse and the like are connected. The PC 200 includes a web browser, and files and data stored in the image forming apparatus 100 and various types of setting information can be viewed and set via the network 300 by an input operation from the keyboard or the mouse, for example. Further, the PC 200 can acquire via the web browser a web screen provided by the image forming apparatus 100 for executing a remote shutdown function for shutting off the power supply of the image forming apparatus 100. The PC 200 is not limited to a PC, and as long as a web browser function is installed, it may also be a mobile phone or a personal digital assistant.

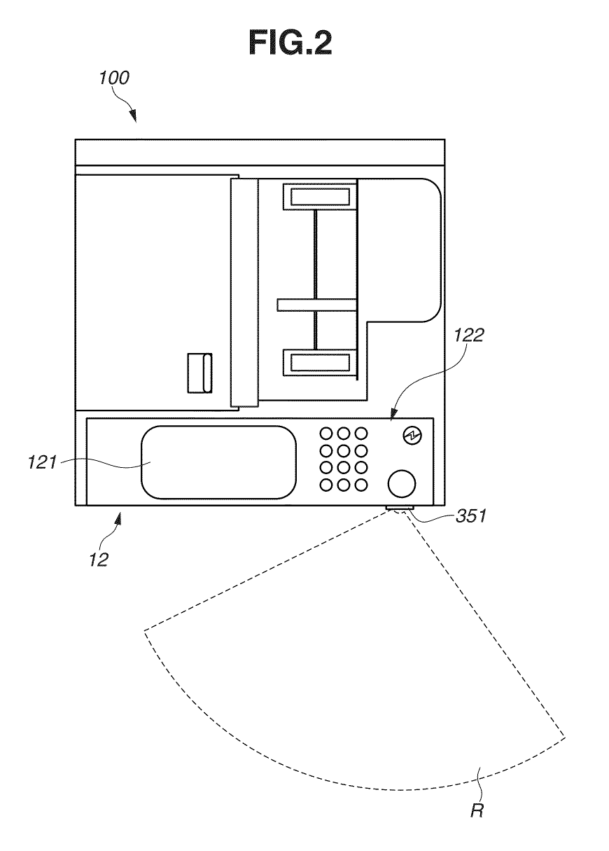

FIG. 2 is a plan view of the image forming apparatus 100.

As illustrated in FIG. 2, the infrared array sensor 351 is attached to a front face of the image forming apparatus 100. The infrared array sensor 351 according to the present exemplary embodiment is provided near an operation unit 12. This infrared array sensor 351 has a detection range R of about 6.0 m.

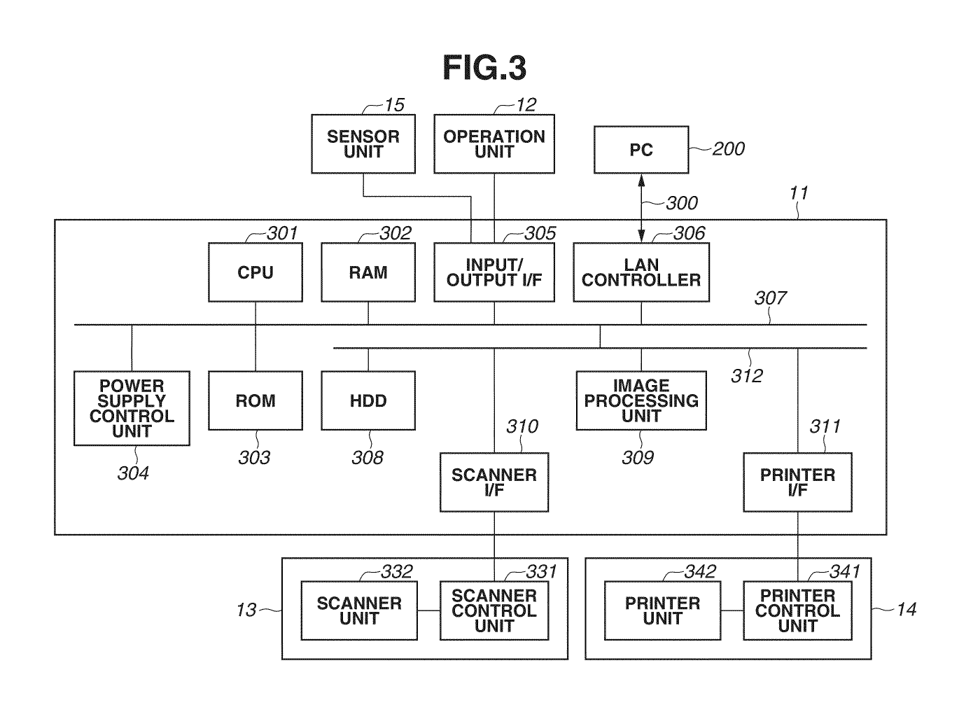

FIG. 3 is a hardware block diagram of the image forming apparatus 100.

A controller 11 that controls the overall operations of the image forming apparatus 100 will now be described in detail with reference to FIG. 3.

As illustrated in FIG. 3, the image forming apparatus 100 includes the controller 11, which performs overall control of the operations of the image forming apparatus 100, the operation unit 12, a scanner unit 13, a printer unit 14, and a sensor unit 15. The controller 11 is electrically connected with the operation unit 12, the scanner unit 13, the printer unit 14, and the sensor unit 15. This controller 11 includes a CPU 301, a RAM 302, a read-only memory (ROM) 303, a power supply control unit 304, an input/output interface (I/F) 305, and a local area network (LAN) controller 306. The CPU 301, the RAM 302, the ROM 303, the power supply control unit 304, the input/output I/F 305, and the LAN controller 306 are connected to a system bus 307. The controller 11 further includes an HDD 308, an image processing unit 309, a scanner I/F 310, and a printer I/F 311. The HDD 308, the image processing unit 309, the scanner I/F 310, and the printer I/F 311 are connected to an image bus 312.

The CPU 301 performs overall control of access to and from various connected devices, based on control programs stored in the ROM 303, and performs overall control of various processes that are executed by the controller 11. The RAM 302 serves as a system work memory for the CPU 301 to operate. This RAM 302 also serves as a memory for temporally storing image data. The ROM 303 stores a boot program of the apparatus, for example. The power supply control unit 304 controls each switch to control the power supply to each of the units in the image forming apparatus 100. The details of the power supply control unit 304 will be described below. The input/output I/F 305 is an interface unit for connecting the operation unit 12 and the sensor unit 15 with the system bus 307. This input/output I/F 305 receives image data for display on the operation unit 12 from the system bus 307, outputs the image data to the operation unit 12, and also outputs information input from the operation unit 12 to the system bus 307. The input/output I/F 305 further outputs a detection result of the infrared array sensor 351 that is output by the sensor unit 15 to the power supply control unit 304. The LAN controller 306 controls the input and output of information performed between the image forming apparatus 100 and the PC 200 connected to the network 300. In the present exemplary embodiment, the LAN controller 306 receives an instruction for shutting down the image forming apparatus 100 (hereinafter referred to as “shutdown instruction”) from the PC 200.

The HDD 308 is a hard disk drive that stores system software and image data. The image processing unit 309 reads image data stored in the RAM 302, and performs image processing such as enlargement or reduction of Joint Photographic Experts Group (JPEG) data or Joint Bi-level Image Experts Group (JBIG) data, and color adjustment. The scanner I/F unit 310 is an interface unit for communicating with a scanner control unit 331 of the scanner unit 13. The printer I/F unit 311 is an interface unit for communicating with a printer control unit 341 of the printer unit 14. The image bus 312 is a transmission path for exchanging image data, and is configured by a bus such as a peripheral component interconnect (PCI) bus or an Institute of Electrical and Electronics Engineers (IEEE) 1394 bus.

The scanner unit 13 generates image data by optically reading an image from a document. The scanner unit 13 includes the scanner control unit 331 and a scanner unit 332. The scanner unit 332, which includes a sheet conveyance motor for conveying a document set in a sheet feeding unit to a read position of the scanner unit 13, is a device that performs physical driving. The scanner control unit 331 controls the operation of the scanner unit 332. The scanner control unit 331 receives, through communication with the CPU 301, setting information set by the user when performing scanner processing, and controls the operation of the scanner unit 332 based on that setting information.

The printer unit 14 forms an image on a recording medium (paper sheet) by an electrophotographic method. This printer unit 14 includes the printer control unit 341 and a printer unit 342. The printer unit 342, which includes a motor for rotating a photosensitive drum, a motor for rotating a fixing device, and a sheet conveyance motor, is a device that performs physical driving. The printer control unit 341 controls the operation of the printer unit 342. The printer control unit 341 receives, through communication with the CPU 301, setting information set by the user when performing print processing, and controls the operation of the printer unit 342 based on that setting information.

The sensor unit 15 will be described below.

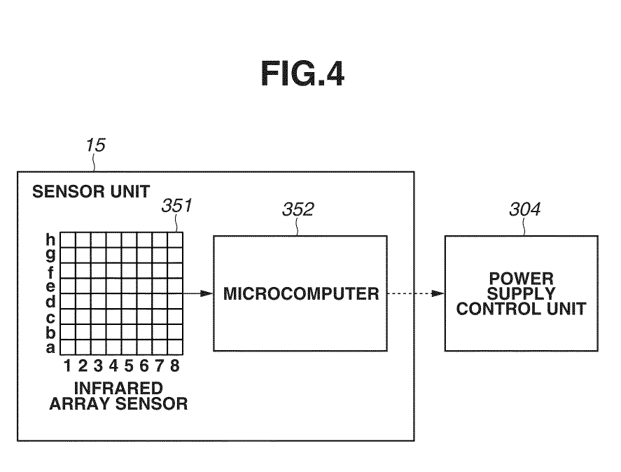

FIG. 4 is a block diagram illustrating the details of the sensor unit 15.

As illustrated in FIG. 4, the sensor unit 15 includes the infrared array sensor 351 and a microcomputer 352 that analyzes information output from the infrared array sensor 351.

The infrared array sensor 351 is a sensor in which thermopile elements 1a to 8h that receive infrared rays are arranged in a matrix. Each of the thermopile elements 1a to 8h of the infrared array sensor 351 receives infrared rays radiated from a person, for example, and outputs information indicating temperature to the microcomputer 352. This information indicating temperature is, for example, a voltage value. The microcomputer 352 measures the temperature of an object such as a person by comparing voltage values output from the thermopile elements 1a to 8h with a reference voltage value. The information indicating temperature that is output to the microcomputer 352 may be an analog value or a digital value. The infrared array sensor 351 in the present exemplary embodiment is provided for detecting a person approaching the image forming apparatus 100. The infrared array sensor 351 is therefore attached facing obliquely upward so as to face a person's face that is not covered by clothing to enable a person's temperature to be accurately measured. The attachment direction of the infrared array sensor 351 is not limited to the obliquely upward direction, the infrared array sensor 351 may also face obliquely downward to face a person's feet.

In addition, the microcomputer 352 determines whether a person approaches the image forming apparatus 100, based on the information indicating temperature that is output from the thermopile elements 1a to 8h. If the microcomputer 352 determines that a person approaches the image forming apparatus 100, the microcomputer 352 outputs information indicating that a person approaches the image forming apparatus 100 to the power supply control unit 304. If the number of thermopile elements 1a to 8h each outputting information indicating a temperature equal to or greater than a predetermined temperature (e.g., 30° C.) is equal to or greater than a predetermined number (e.g., 20 elements or more), the microcomputer 352 determines that a person approaches the image forming apparatus 100. The method for determining whether a person approaches the image forming apparatus 100 is not limited to the above-described method. For example, it may be determined that a person approaches the image forming apparatus 100 if the number of thermopile elements 1a to 8h each outputting information indicating a temperature equal to or greater than a predetermined temperature (e.g., 30° C.) has increased during a predetermined period by a predetermined number or more. Further, it may also be determined that a person approaches the image forming apparatus 100 if any of the thermopile elements among the thermopile elements 1a to 8h (e.g., the thermopile elements 1e to 8h in rows e, f, g, and h) has output information indicating a temperature equal to or greater than a predetermined temperature.

If the microcomputer 352 determines that a person approaches the image forming apparatus 100, the power supply control unit 304 controls the image forming apparatus 100 that is in a sleep state to switch to a standby state. Further, if the microcomputer 352 determines that the person is no longer present near the image forming apparatus 100, the image forming apparatus 100 that is in the standby state may be switched to the steep state.

Although an example using an infrared array sensor including thermopile elements arranged in a matrix has been described as the sensor detecting that a person is approaching the image forming apparatus 100, the type of sensor is not limited to such an infrared array sensor. Examples of sensor types that can be used include a light sensor that detects light, a strain sensor that is deformed by physical force, a magnetic sensor that detects magnetism, and a pyroelectric sensor that utilizes a pyroelectric effect. Further, the elements used in the infrared array sensor do not have to be arranged in a matrix. The elements may be arranged in a line, or a single element may be used.

### <Power Supply Circuit of Image Forming Apparatus 100>

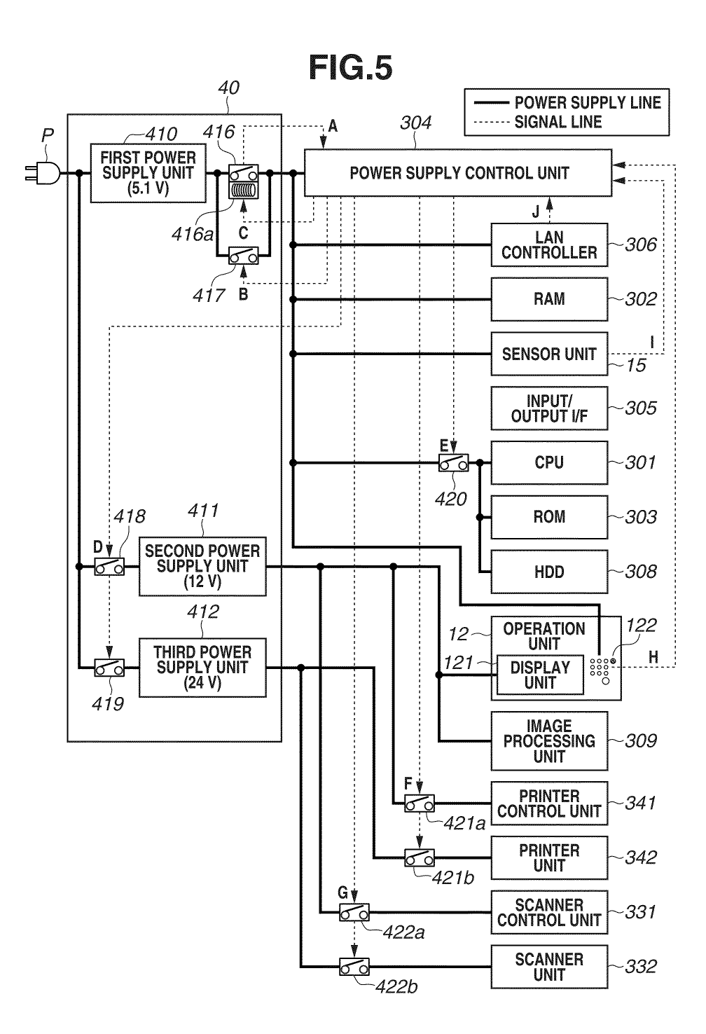

FIG. 5 is a power supply circuit diagram of the image forming apparatus 100. Power generated by a power supply unit 40 is supplied to each of the above-described units in the image forming apparatus 100. The power supply unit 40 includes a first power supply unit 410, a second power supply unit 411, and a third power supply unit 412.

The first power supply unit 410 converts alternating-current power supplied via a plug P into direct-current power (e.g., 5.1 V (first output power)). This direct-current power is supplied to the devices (the CPU 301, the RAM 302, the ROM 303, the power supply control unit 304, the input/output I/F 305, the LAN controller 306, the HDD 308, the sensor unit 315, and buttons 122 of the operation unit 12) of a first power supply system.

The second power supply unit 411 converts alternating-current power supplied via the plug P into direct-current power (e.g., 12 V (second output power)). This direct-current power is supplied to the devices (a display unit 121 of the operation unit 12, the image processing unit 309, the printer control unit 341 of the printer unit 14, and the scanner control unit 331 of the scanner unit 13) of a second power supply system.

The third power supply unit 412 converts alternating-current power supplied via the plug P into direct-current power (e.g., 24 V), and supplies this direct-current power to the devices (the printer unit 342 and the scanner unit 332) of a third power supply system.

A power supply switch 416 that is switched between an ON state and an OFF state by a user operation is provided between the first power supply unit 410 and the first power supply system devices. A signal A indicating the state (the ON state or the OFF state) of the power supply switch 416 is input to the power supply control unit 304. If the signal A input to the power supply control unit 304 indicates the OFF state, the CPU 301 of the image forming apparatus 100 executes shutdown processing. During this shutdown processing, the supply of power from an alternating-current power supply to the image forming apparatus 100 is stopped after the execution of, for example, processing for closing files, processing for saving the contents of the RAM 302 in the HDD 308, and network disconnection processing.

The power supply unit 40 further includes a switch 417 including a field-effect transistor (FET) arranged in parallel with the power supply switch 416. This switch 417 is switched from an ON state to an OFF state, or from the OFF state to the ON state, by a control signal B that is output from the power supply control unit 304. When the above-described shutdown processing is executed, the switch 417 is switched to the OFF state by the control of the power supply control unit 304.

The power supply switch 416 is provided with a solenoid 416a. Voltage is applied to this solenoid 416a according to a control signal C that is output from the power supply control unit 304, so that the power supply switch 416 switches to the OFF state. When an auto-shutdown function or a remote shutdown function provided in the image forming apparatus 100 is executed, the solenoid 416a is driven according to the state of the control signal B output from the power supply control unit 304, so that the power supply switch 416 switches to the OFF state. The auto-shutdown function is a function of causing the image forming apparatus 100 to perform the shutdown processing if a predetermined period has elapsed without the execution of a user operation or a job in the sleep state. Further, the remote shutdown function is a function of causing the image forming apparatus 100 to perform the shutdown processing according to a shutdown instruction transmitted from the PC 200.

A relay switch 418 is provided between the plug P and the second power supply unit 411. Further, a relay switch 419 is provided between the plug P and the third power supply unit 412. The relay switches 418 and 419 are switched from an ON state to an OFF state, or from the OFF state to the ON state, according to a control signal D output from the power supply control unit 304. When the image forming apparatus 100 switches to the sleep state, the relay switches 418 and 419 switch to the OFF state.

A switch 420 is provided between the power supply switch 416 and the CPU 301, the ROM 303, and the HDD 308. The switch 420 is switched from an ON state to an OFF state, or from the OFF state to the ON state, according to a control signal E output from the power supply control unit 304.

A switch 421a is provided between the second power supply unit 411 and the printer control unit 341. Further, a switch 421b is provided between the third power supply unit 412 and the printer unit 342. These switches 421a and 421b are switched from an ON state to an OFF state, or from the OFF state to the ON state, according to a control signal F output from the power supply control unit 304.

A switch 422a is provided between the second power supply unit 411 and the scanner control unit 331. Further, a switch 422b is provided between the third power supply unit 412 and the scanner unit 332. These switches 422a and 422b are switched from an ON state to an OFF state, or from the OFF state to the ON state, according to a control signal G output from the power supply control unit 304.

### <Power State of Image Forming Apparatus 100>

The image forming apparatus 100 can be switched to the standby state, the sleep state, and the power off state. Further, the image forming apparatus 100 can also be switched to other states (e.g., an operating state (a printing-in-progress state, a scanning-in-progress state etc.), a hibernation state etc.) than the above-described states.

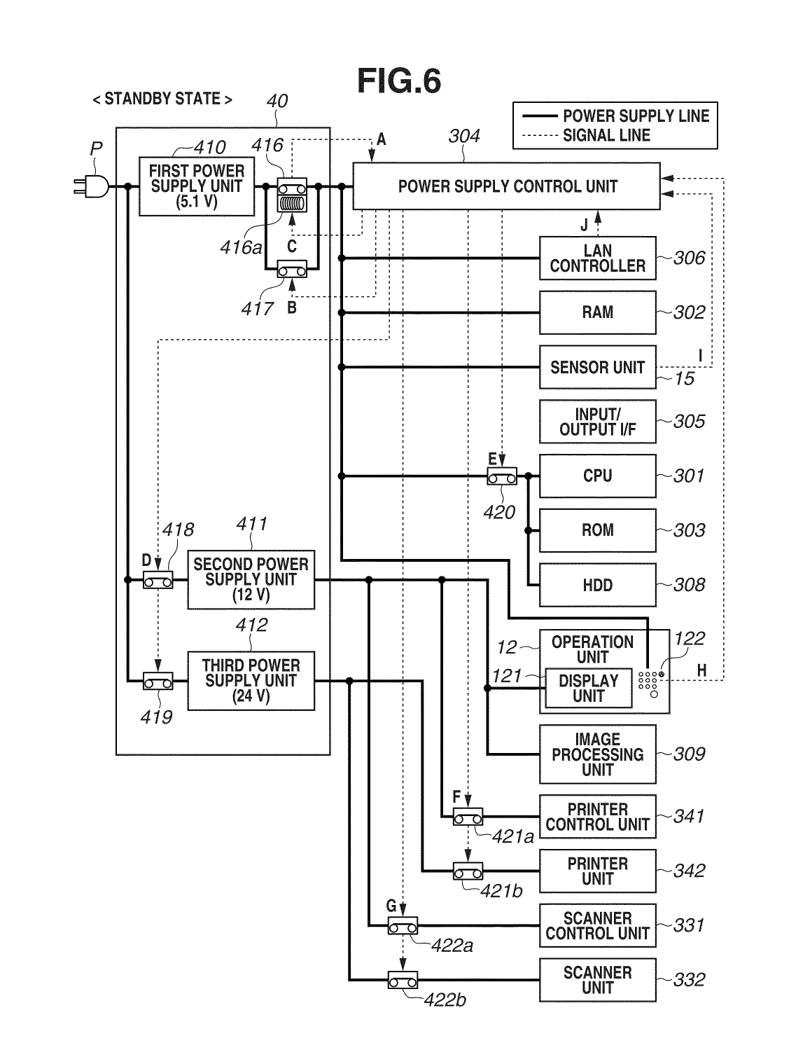

FIG. 6 illustrates the image forming apparatus 100 in the standby state. The standby state is a state to which the image forming apparatus 100 switches when the execution of printing or scanning has been completed. In the standby state, power is supplied to the first to third power supply system devices via the plug P. In the standby state, the switches 416, 417, 418, 419, 420, 421a, 421b, 422a, and 422b are in the ON state.

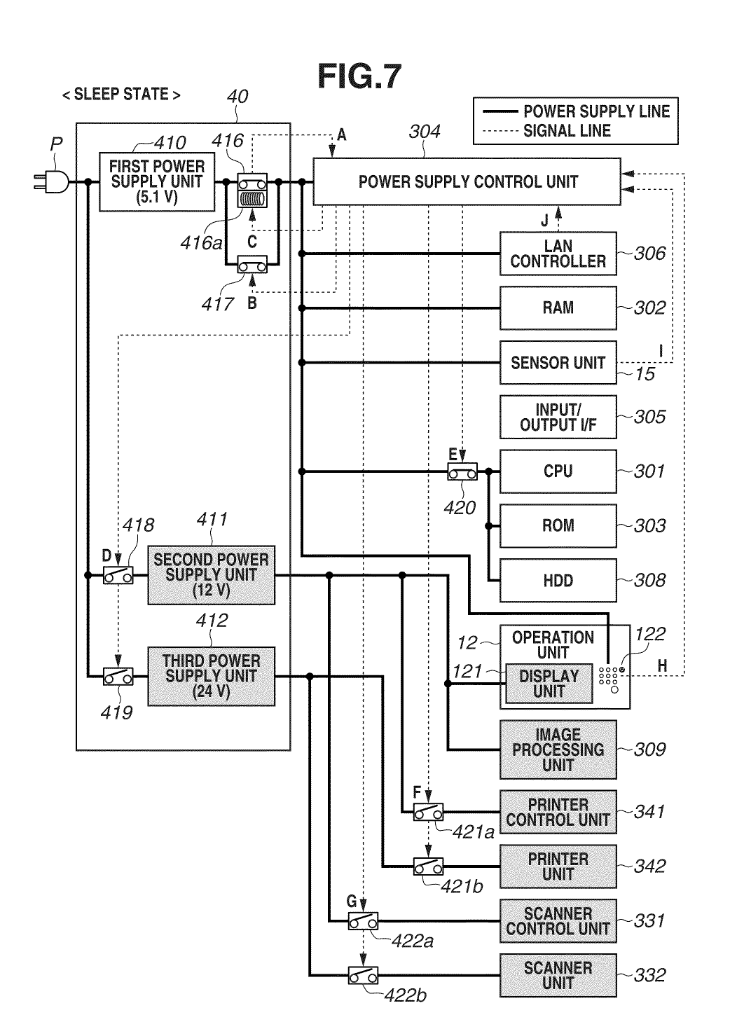

FIG. 7 illustrates the image forming apparatus 100 in the sleep state. The sleep state is a state in which power is supplied to the locations that are necessary for supplying power to the RAM 302 on which a program being executed is running and for recovery to the standby state. In other words, the sleep state is a state in which operations from the various buttons 122 of the operation unit 12 and jobs from the PC 200 can be received. When any of the buttons 122 is operated by the user or when a job is received from the PC 200, the processing can be restarted using the program that is running on the RAM 302. Thus, compared with switching from the power off state to the standby state, the image forming apparatus 100 can recover from the sleep state to the standby state at higher speed. When any of the buttons 122 of the operation unit 12 is pressed by the user in the sleep state, the state of a signal H changes (e.g., changes to a Hi-level). Further, in the sleep state, when the microcomputer 352 of the sensor unit 15 has detected a person approaching the image forming apparatus 100, the state of a signal I output from the microcomputer 352 changes (e.g., changes to a Hi-level). In addition, in the sleep state, when the LAN controller 306 receives a job, for example, the state of a signal J output from the LAN controller 306 changes (e.g., changes to a Hi-level). When the state of the input signal H, I, or J changes, the power supply control unit 304 controls the image forming apparatus 100 to switch to the standby state. Specifically, the power supply control unit 304 controls the signals D, F, and G. Consequently, the switches 418, 419, 421a, 421b, 422a, and 422b enter the ON state. As illustrated in FIG. 7, in the sleep state, while the switches 416, 417, and 420 are in the ON state, the switches 418, 419, 421a, 421b, 422a, and 422b are in the OFF state.

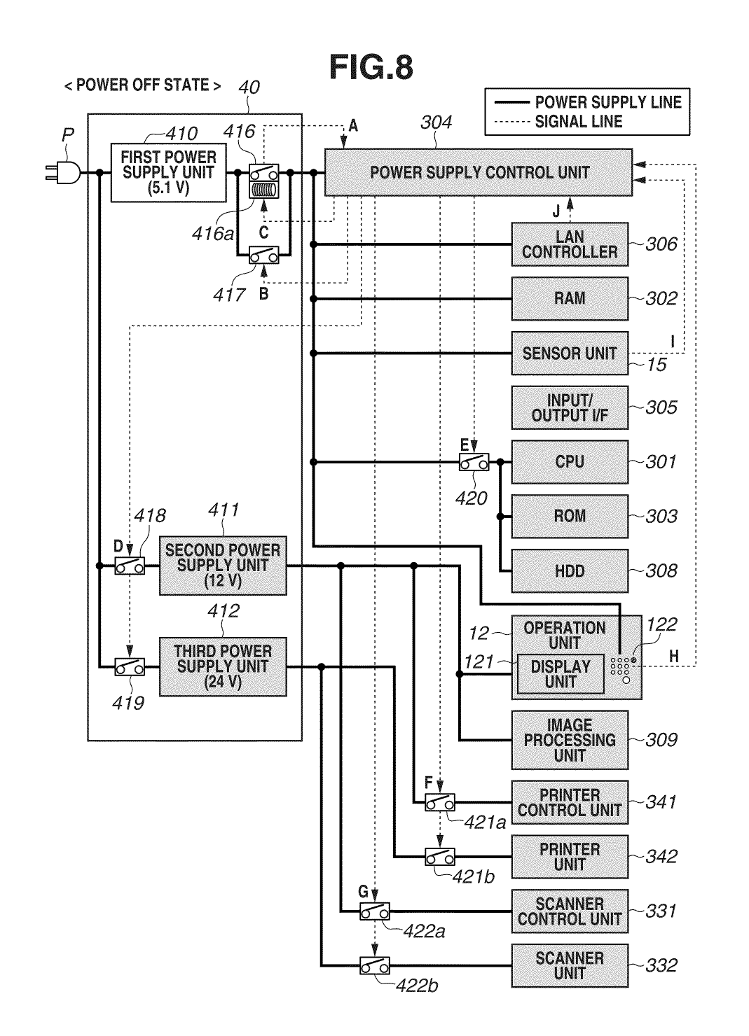

FIG. 8 illustrates the image forming apparatus 100 in the power off state. The power off state is a state in which power is not supplied to the image forming apparatus 100 via the plug P. Specifically, when the power supply switch 416 is in the OFF state, the image forming apparatus 100 is in the power off state. As illustrated in FIG. 8, the switches 416, 417, 418, 419, 420, 421a, 421b, 422a, and 422b are in the OFF state.

### <Remote Shutdown Processing>

The image forming apparatus 100 according to the present exemplary embodiment has the remote shutdown function. The remote shutdown function is a function by which the image forming apparatus 100 executes shutdown processing based on a shutdown instruction transmitted from the PC 200 via the network 300.

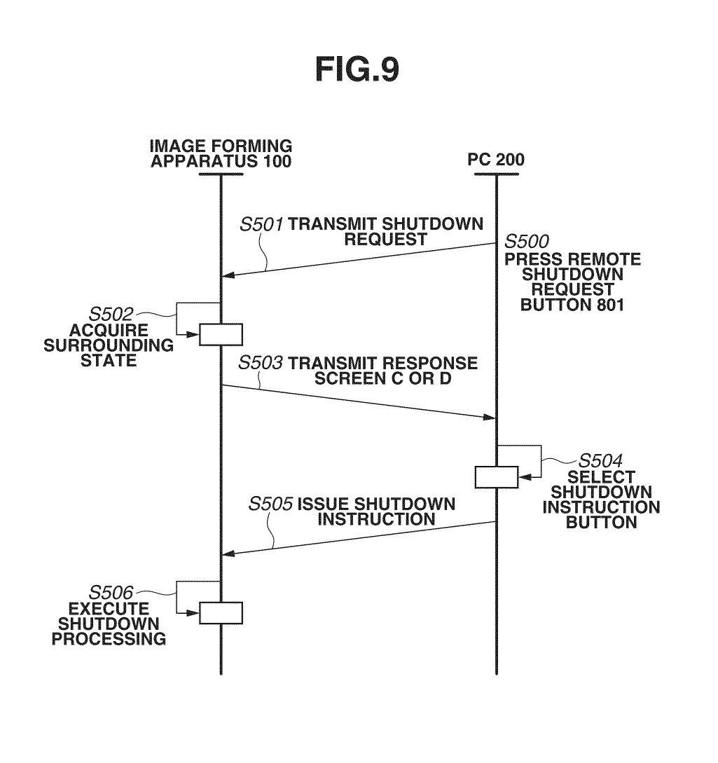

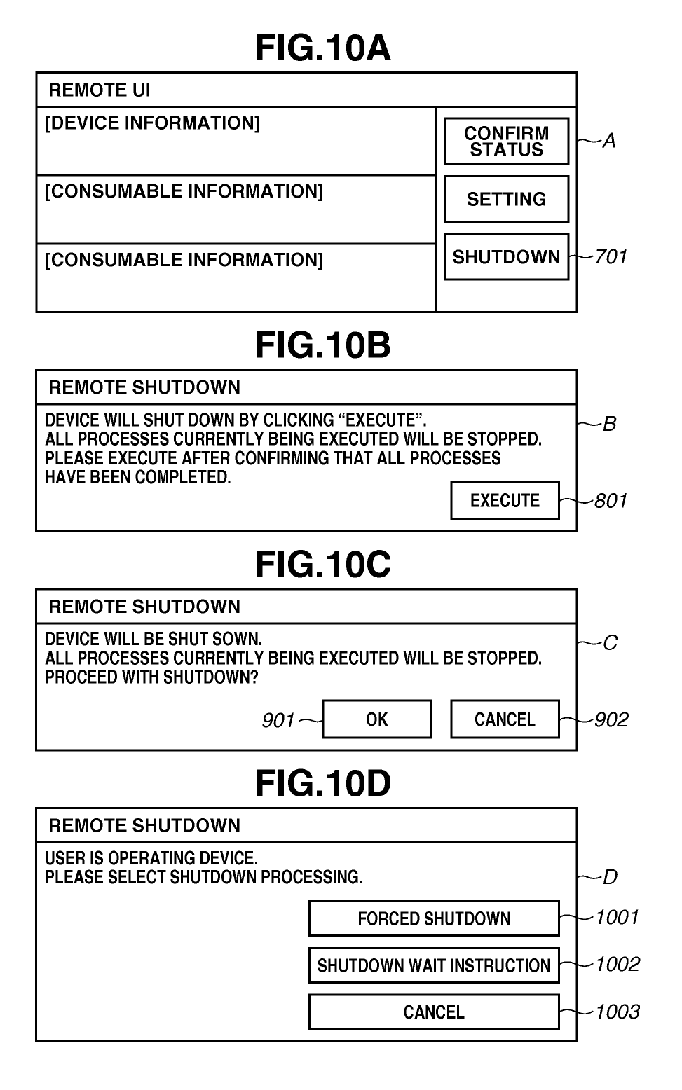

FIG. 9 is a diagram illustrating processing that is executed between the PC 200 and the image forming apparatus 100 when remotely shutting down the image forming apparatus 100 from the PC 200. FIGS. 10A, 10B, 10C, and 10D each illustrate a screen displayed on the display unit 121 of the PC 200.

First, the user starts a web browser to display a remote user interface (UI) screen A for confirming from the PC 200 the state of the image forming apparatus 100 and the remaining amount of consumables in the image forming apparatus 100. Further, the PC 200 issues a request to the image forming apparatus 100 for acquiring the remote UI screen A (FIG. 10A). The image forming apparatus 100 receives this request, and provides the remote UI screen A to the PC 200.

Then, to shut down the image forming apparatus 100 from the PC 200, the user selects a shutdown button 701 displayed on the remote UI screen A. When the shutdown button 701 is selected, the PC 200 issues a request to the image forming apparatus 100 for acquiring a screen B for transmitting a shutdown request to the image forming apparatus 100. The image forming apparatus 100 receives this request, and provides the screen B (FIG. 10B) for requesting shutdown of the image forming apparatus 100 to the PC 200. As illustrated in FIG. 10B, a remote shutdown request button 801 for requesting the image forming apparatus 100 to execute the shutdown processing is displayed on the screen B.

When the remote shutdown request button 801 is selected by the user in step S500, the processing proceeds to step S501. In step S501, a shutdown request is transmitted from the PC 200 to the image forming apparatus 100. When the image forming apparatus 100 has received the shutdown request from the PC 200, in step S502, the image forming apparatus 100 checks whether a person is present in the detection range R of the infrared array sensor 351. In step S503, the image forming apparatus 100 transmits a response screen C or a response screen D according to whether a person is present in the detection range R of the infrared array sensor 351.

If no person is present in the detection range R, the PC 200 displays the response screen C illustrated in FIG. 10C. As illustrated in FIG. 10C, on the response screen C, a shutdown instruction button 901 for instructing the image forming apparatus 100 to execute the shutdown processing, and a cancel button 902 for cancelling the request for the shutdown processing are displayed. The shutdown instruction button 901 will be hereinafter referred to as the “SD button 901”.

If any person is present in the detection range R, the PC 200 displays the response screen D illustrated in FIG. 10D. As illustrated in FIG. 10D, on the response screen D, a forced shutdown instruction button 1001 (hereinafter, referred to as the “forced SD button 1001”), a shutdown wait instruction button 1002 (hereinafter, referred to as the “wait instruction button 1002”), and a cancel button 1003 are displayed. The forced SD button 1001 is provided for forcibly causing the image forming apparatus 100 to execute the shutdown processing. The wait instruction button 1002 is provided for executing the shutdown processing when a person is no longer present in the detection range R. The cancel button 1003 is provided for cancelling the shutdown processing request.

The PC 200 displays the response screen C or D acquired from the image forming apparatus 100 on the web browser. When the button 901, 1001, or 1002 for executing remote shutdown processing is selected by the user in step S504, the processing proceeds to step S505. In step S505, a remote shutdown instruction is transmitted from the PC 200 to the image forming apparatus 100. If the remote shutdown instruction has been received from the PC 200, in step S506, the image forming apparatus 100 executes the remote shutdown processing according to this instruction. Specifically, if the SD button 901 is pressed on the response screen C, the image forming apparatus 100 executes the shutdown processing in response to the pressing of this button 901. Further, if the forced SD button 1001 is pressed on the response screen D, the image forming apparatus 100 executes the shutdown processing even if a person is present in the detection range R. In addition, if the wait instruction button 1002 is pressed on the response screen D, the image forming apparatus 100 executes the shutdown processing when a person is no longer present in the detection range R.

<Processing Executed by Image Forming Apparatus 100 when Shutdown Request is Received from PC 200>

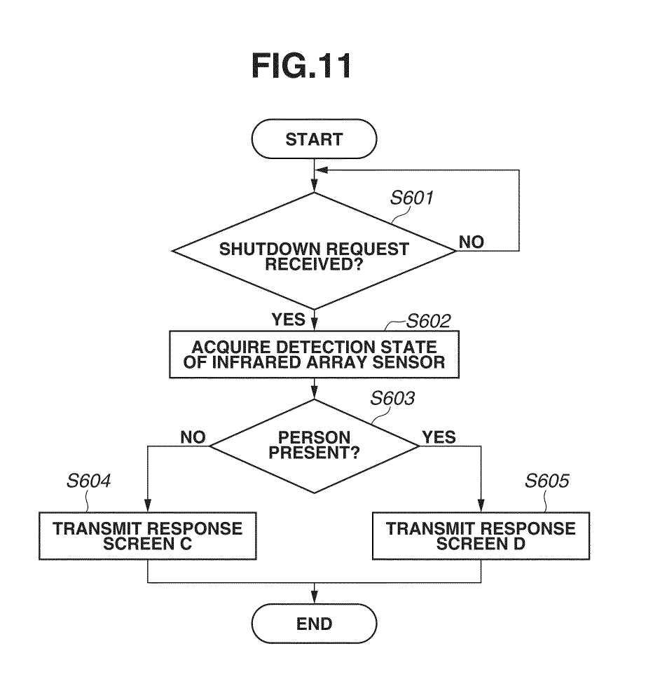

FIG. 11 is a flowchart illustrating processing that is executed by the image forming apparatus 100 that has received a shutdown request. The processing illustrated in the flowchart of FIG. 11 is executed by the CPU 301 loading a control program stored in the ROM 303 into the RAM 302.

First, in step S601, the CPU 301 determines whether a shutdown request has been received from the PC 200. The shutdown request is transmitted from the PC 200 to the image forming apparatus 100 in response to the user selecting the remote shutdown request button 801 displayed on the screen B (refer to FIG. 10B).

If the CPU 301 determines that the shutdown request has been received (YES in step S601), in steps S602 and S603, the CPU 301 checks whether a person is present in the detection range R of the infrared array sensor 351. Specifically, in step S602, the CPU 301 acquires information indicating whether a person is present in the detection range R of the infrared array sensor 351 from the microcomputer 352 of the sensor unit 15. In step S603, based on the information acquired in step S602, the CPU 301 determines whether a person is in the detection range R of the infrared array sensor 351. Then, if the CPU 301 determines that no person is present in the detection range R of the infrared array sensor 351 (NO in step S603), in step S604, the CPU 301 transmits the response screen C to the LAN controller 306. On the other hand, if the CPU 301 determines that a person is present in the detection range R of the infrared array sensor 351 (YES in step S603), in step S605, the CPU 301 transmits the response screen D to the LAN controller 306.

<Processing Executed by Image Forming Apparatus 100 when Shutdown Instruction is Received from PC 200>

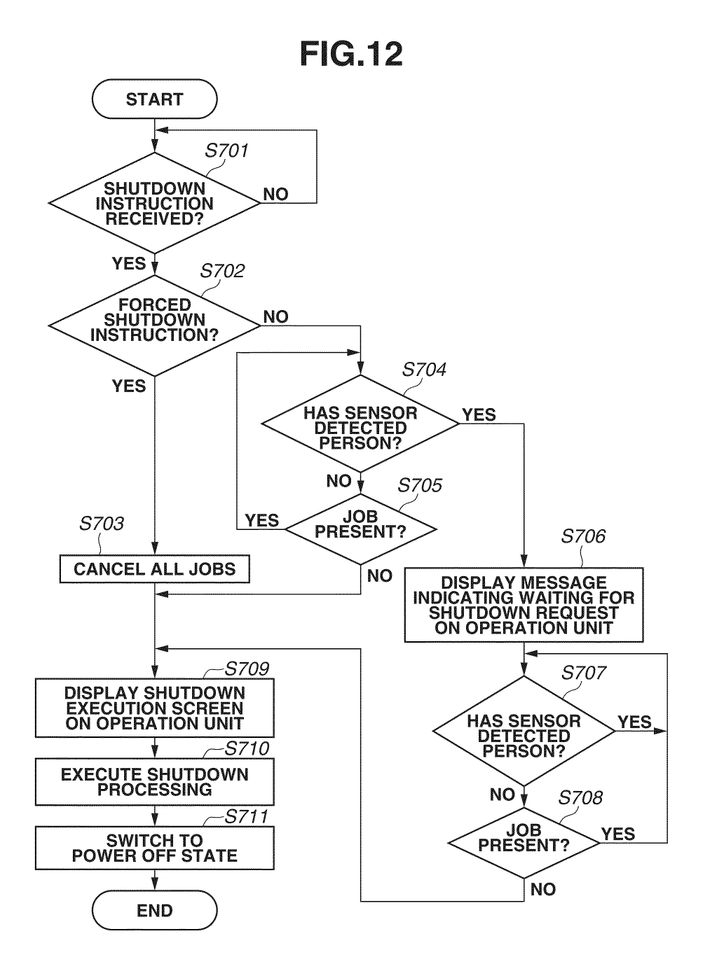

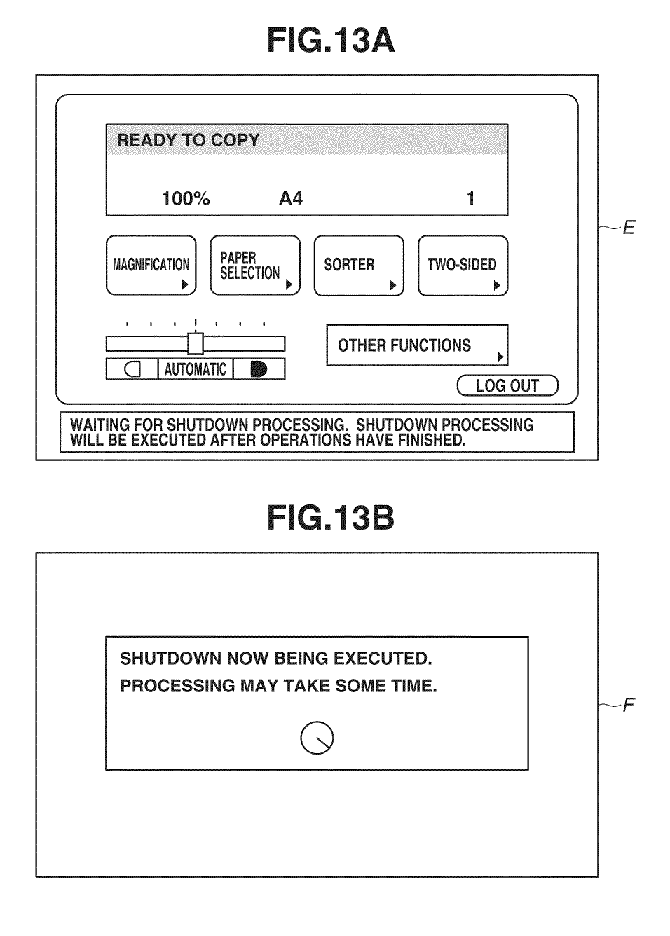

FIG. 12 is a flowchart illustrating processing executed by the image forming apparatus 100 when a shutdown instruction is received from the PC. FIG. 13A illustrates a status display example that is displayed on the display unit 121 of the image forming apparatus 100 indicating that the image forming apparatus 100 is waiting for a shutdown request. FIG. 13B illustrates a shutdown execution screen that is displayed on the display unit 121 of the image forming apparatus 100.

First, in step S701, the CPU 301 determines whether a shutdown instruction has been received from the PC 200. This shutdown instruction is transmitted from the PC 200 to the image forming apparatus 100 when the SD button 901, the forced SD button 1001, or the wait instruction button 1002 is selected.

If the CPU 301 determines that the shutdown instruction has been received (YES in step S701), in step S702, the CPU 301 checks the type of this shutdown instruction. If the shutdown instruction is a shutdown instruction transmitted due to the selection of the SD button 901 or the forced SD button 1001 (YES in step S702), in step S703, the CPU 301 cancels the jobs stored in the image forming apparatus 100. The jobs cancelled in step S703 include jobs currently being executed and jobs waiting to be executed, such as print jobs and copy jobs.

On the other hand, if the shutdown instruction is a shutdown instruction transmitted due to the selection of the wait instruction button 1002 (NO in step S702), in step S704, the CPU 301 determines whether a person is present in the detection range R of the infrared array sensor 351. If the CPU 301 determines that no person is present in the detection range R of the infrared array sensor 351 (NO in step S704), in step S705, the CPU 301 checks whether an unprocessed job is present in the image forming apparatus 100. If the CPU 301 determines that an unprocessed job is present in the image forming apparatus 100 (YES in step S705), the processing returns to step S704, and in step S704, the CPU 301 checks whether a person is present in the detection range R of the infrared array sensor 351 until all unprocessed jobs have been processed. Thus, in the present exemplary embodiment, if a person is present in the detection range R of the infrared array sensor 351, the image forming apparatus 100 is restricted from executing shutdown processing. The image forming apparatus 100 does not immediately execute shutdown processing even if a shutdown instruction transmitted from the PC 200 is received. The image forming apparatus 100 executes the shutdown processing when a person is no longer present in the detection range R.

On the other hand, if the CPU 301 determines that a person is present in the detection range R of the infrared array sensor 351 (YES in step S704), in step S706, as illustrated in FIG. 13A, a screen E indicating that the image forming apparatus 100 is waiting for shutdown processing to be executed is displayed on the display unit 121. Then, in step S707, the CPU 301 determines whether a person is present in the detection range R of the infrared array sensor 351. When a person is no longer present in the detection range R (NO in step S707), in step S708, the CPU 301 checks whether an unprocessed job is present in the image forming apparatus 100.

When stored jobs have been cancelled in step S703, in step S709, as illustrated in FIG. 13B, the CPU 301 performs control so that a screen F indicating that shutdown processing is now being executed is displayed on the display unit 121. Further, if the CPU 301 determines in step S705 or S708 that an unprocessed job is no longer present (NO in step S705 or S708), in step S709, as illustrated FIG. 13B, the CPU 301 performs control so that the screen F is displayed on the display unit 121. After the screen F has been displayed, the CPU 301 executes shutdown processing. Specifically, in step S710, the CPU 301 executes processing such as processing for closing files, processing for saving the contents of the RAM 302 in the HDD 308, and network disconnection processing, according to control programs stored in the HDD 308. In addition, the CPU 301 controls the power supply control unit 304 so that the supply of power from the alternating-current power supply via the plug P is stopped. The power supply control unit 304 switches the switches 416, 417, 418, 419, 420, 421a, 421b, 422a, and 422b to the OFF state. As a result, in step S711, the image forming apparatus 100 switches to the power off state. The power supply switch 416 is switched to the OFF state by the power supply control unit 304 applying a voltage to the solenoid 416a.

As described above, according to the first exemplary embodiment, when a person is present near the image forming apparatus 100, the user can make a selection on the screen of the PC 200 whether to forcibly execute shutdown processing or to execute shutdown processing after the person has left.

In the first exemplary embodiment, the description has been given of a case in which two kinds of shutdown instructions are transmitted from the PC 200 to the image forming apparatus 100. The two kinds of shutdown instructions refer to an instruction for shutting down the image forming apparatus 100 regardless of whether a person is present, and an instruction for shutting down the image forming apparatus 100 according to, as one condition, the determination that a person is no longer present.

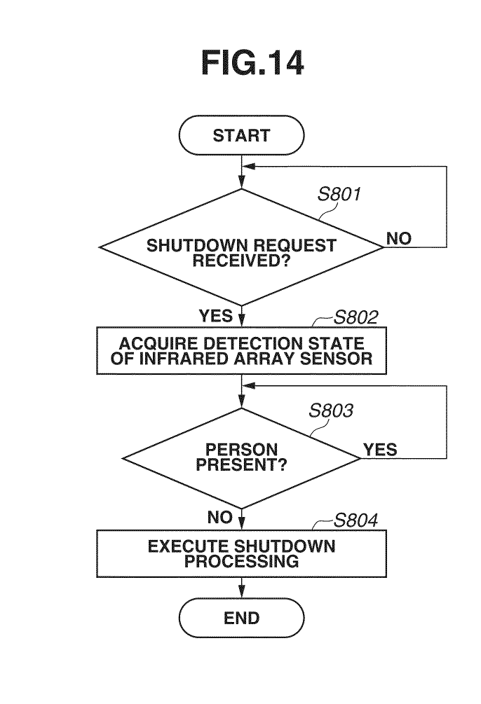

In a second exemplary embodiment, one kind of shutdown instruction is transmitted from the PC 200. In the second exemplary embodiment, this one kind of shutdown instruction transmitted from the PC 200 is transmitted to the image forming apparatus 100 when the OK button 901 (the shutdown instruction button 901) on the above-described response screen C (refer to FIG. 10C) is pressed. In the second exemplary embodiment, a screen that lets the user select forced shutdown or shutdown wait is not displayed. As illustrated in FIG. 14, if the image forming apparatus 100 has received this shutdown instruction (YES in step S801), in steps S802 and S803, the image forming apparatus 100 checks whether a person is present. If a person is present (YES in step S803), the image forming apparatus 100 delays the shutdown processing until the person is no longer present. On the other hand, if no person is present (NO in step S803), in step S804, the image forming apparatus 100 immediately executes shutdown processing.

In the second exemplary embodiment, after the shutdown instruction has been received from the PC 200, a determination is made whether a person approaching the image forming apparatus 100 is present.

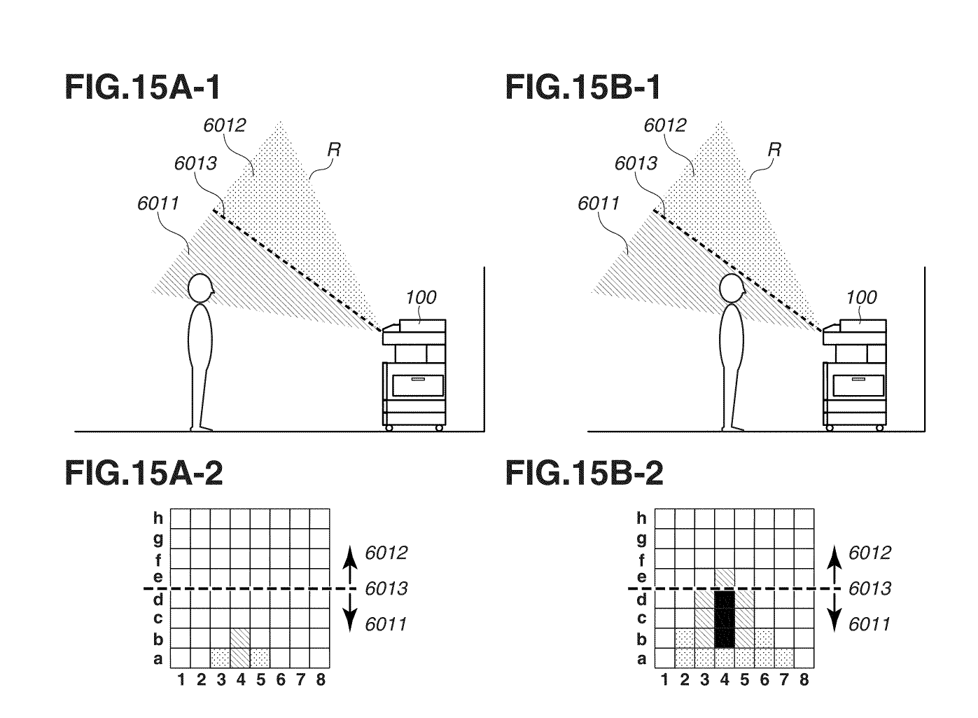

In the above-described exemplary embodiments, although it is determined that a person is present in the detection range R when a plurality of elements of the infrared array sensor 351 detects a temperature equal to or greater than a predetermined temperature, the determination method is not limited to this method. For example, as illustrated in FIGS. 15A-1, 15A-2, 15B-1, and 15B-2, it may be determined that a person is approaching the image forming apparatus 100 if a specific element of the infrared array sensor 351 attached facing obliquely upward detects heat. Specifically, the microcomputer 352 determines that a person approaches the image forming apparatus 100 when the elements 1e to 8h in lines e to h above an imaginary line 6013 detect a user's heat. On the other hand, if the elements 1e to 8h in lines e to h above the line 6013 do not detect a user's heat, the microcomputer 352 determines that no person is approaching the image forming apparatus 100. Even if the elements 1a to 8d in lines a to d below the line 6013 detect heat of a person, the microcomputer 352 determines that this person is a passerby. In another exemplary embodiment, the image forming apparatus 100 is restricted from being shutdown when the elements 1e to 8h in lines e to h above the imaginary line 6013 detect a user's heat. According to this configuration, shutdown can be performed in a case in which a person being present in the detection range R of the image forming apparatus 100 is a passerby.

A remote shutdown function has been described above in which the shutdown processing is executed according to an instruction transmitted from the remote PC 200. However, exemplary embodiments of the disclosure are not limited to a remote shutdown. Specifically, the disclosure may also be applied to cases in which an auto-shutdown function or a weekly shutdown function is executed. The auto shutdown function is a function of executing shutdown processing when a predetermined period has elapsed without the user using the apparatus. Further, the weekly shutdown function is a function of executing shutdown processing at a pre-specified time.

Further, in the above exemplary embodiments, the description has been given of an example in which shutdown processing is executed if the CPU 301 determines that a person is no longer present in the detection range R of the infrared array sensor 351 (NO in step S704, and NO in step S707). However, the apparatus may also be configured to perform control so that shutdown processing is not executed for a predetermined period even if a person is no longer present in the detection range R of the infrared array sensor 351. Shutdown processing is restricted for this predetermined period even if a person is no longer present in the detection range R of the infrared array sensor 351. As a result, if a person is temporarily not present in the detection range R of the infrared array sensor 351, shutdown processing is not executed if a person returns to the detection range R within the predetermined period.

In addition, although the description has been given of an example in which processing for closing files and the like are performed in the shutdown processing, the supply of power to the image forming apparatus 100 from the alternating-current power supply may also be stopped without performing processing for closing files and the like.

In the above exemplary embodiments, although an image forming apparatus that includes a printer unit has been described, the disclosure may also be applied to an information processing apparatus such as a PC.

The functions illustrated in the flowcharts of the above-described exemplary embodiments can also be realized by executing software (a program) acquired via a network or various storage media with a processing device (a CPU or a processor) of a computer, for example.

According to the information processing apparatus of the disclosure, when a person is present near the apparatus, the power supply of the information processing apparatus can be controlled via a network.

Embodiments of the disclosure can also be realized by a computer of a system or apparatus that reads out and executes computer executable instructions recorded on a storage medium (e.g., non-transitory computer-readable storage medium) to perform the functions of one or more of the above-described embodiment(s) of the disclosure, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2013-272038 filed Dec. 27, 2013, which is hereby incorporated by reference herein in its entirety.

What is claimed is:

1. An information processing apparatus capable of communicating with an external device, the information processing apparatus comprising:
a detection unit configured to detect a person being present near the information processing apparatus;
a transmission unit configured to, if the detection unit detects a person near the information processing apparatus, transmit a screen for selecting on the external device whether to forcibly shut down the information processing apparatus or to wait shutdown of the information processing apparatus; and
a control unit configured to shut down the information processing apparatus if an instruction for forcibly shutting down the information processing apparatus has been issued on the screen displayed on the external device, and if an instruction for waiting shutdown of the information processing apparatus has been issued on the screen displayed on the external device, to restrict the shutdown until the detection unit no longer detects a person near the information processing apparatus.

2. The information processing apparatus according to claim 1, wherein the detection unit includes a sensor configured to detect presence of a person by receiving infrared rays radiated from the person.

3. The information processing apparatus according to claim 1, wherein the control unit is configured to execute shutdown of the information processing apparatus when the detection unit no longer detects the person who had been present near the information processing apparatus.

4. The information processing apparatus according to claim 1, wherein the control unit is configured to, if the instruction for forcibly shutting down the information processing apparatus has been issued on the screen, shut down the information processing apparatus according to the instruction even if the detection unit detects that a person is present near the information processing apparatus.

5. The information processing apparatus according to claim 1, wherein the transmission unit is configured to transmit to the external device information indicating presence or absence of a person near the information processing apparatus.

6. The information processing apparatus according to claim 1, further comprising a display unit configured to, if shutdown of the information processing apparatus is executed, display a screen indicating that the shutdown is being executed.

7. The information processing apparatus according to claim 1, wherein the shutdown includes processing for stopping power supply to the information processing apparatus.

8. A method for controlling an information processing apparatus that is capable of communicating with an external device, the method comprising:
detecting a person being present near the information processing apparatus;
transmitting, if it is detected that a person is present near the information processing apparatus, to the external device a screen for selecting whether to forcibly shut down the information processing apparatus or to wait shutdown of the information processing apparatus; and
performing control to shut down the information processing apparatus if an instruction for forcibly shutting down the information processing apparatus has been issued on the screen displayed on the external device, and if an instruction for waiting shutdown of the information processing apparatus has been issued on the screen displayed on the external device, to restrict the shutdown until a person near the information processing apparatus is no longer detected.

9. A recording medium on which a program is recorded, wherein the program causes a computer in an information processing apparatus capable of communicating with an external device to function as:
a detection unit configured to detect a person being present near the information processing apparatus;
a transmission unit configured to, if the detection unit detects a person near the information processing apparatus, transmit a screen for selecting on the external device whether to forcibly shut down the information processing apparatus or to wait shutdown of the information processing apparatus; and
a control unit configured to shut down the information processing apparatus if an instruction for forcibly shutting down the information processing apparatus has been issued on the screen displayed on the external device, and if an instruction for waiting shutdown of the information processing apparatus has been issued on the screen displayed on the external device, to restrict the shutdown until the detection unit no longer detects a person near the information processing apparatus.

10. An information processing apparatus capable of communicating with an external device, the information processing apparatus comprising:
a receiving unit configured to receive from the external device a shutdown instruction for shutting down the information processing apparatus;
a detection unit configured to detect a person being present near the information processing apparatus; and
a control unit configured to restrict shutdown of the information processing apparatus according to the shutdown instruction received by the receiving unit while the detection unit is detecting presence of a person near the information processing apparatus.

11. The information processing apparatus according to claim 10, wherein the detection unit includes a sensor configured to detect presence of a person by receiving infrared rays radiated from the person.

12. The information processing apparatus according to claim 10, wherein the control unit is configured to execute shutdown of the information processing apparatus when the detection unit no longer detects the person who had been present near the information processing apparatus.

13. The information processing apparatus according to claim 10, further comprising a transmission unit configured to transmit to the external device information indicating presence or absence of a person near the information processing apparatus.

14. The information processing apparatus according to claim 10, further comprising a display unit configured to, if shutdown of the information processing apparatus is executed, display a screen indicating that the shutdown is being executed.

15. The information processing apparatus according to claim 10, wherein the shutdown includes processing for stopping power supply to the information processing apparatus.

16. A method for controlling an information processing apparatus capable of communicating with an external device, the method comprising:
receiving from the external device a shutdown instruction for shutting down the information processing apparatus;
detecting a person being present near the information processing apparatus; and
performing control to restrict shutdown of the information processing apparatus according to the received shutdown instruction while presence of a person near the information processing apparatus is being detected.

17. A recording medium on which a program is recorded, wherein the program causes a computer in an information processing apparatus capable of communicating with an external device to function as:
a receiving unit configured to receive from the external device a shutdown instruction for shutting down the information processing apparatus;
a detection unit configured to detect a person being present near the information processing apparatus; and
a control unit configured to restrict shutdown of the information processing apparatus according to the shutdown instruction received by the receiving unit while the detection unit is detecting presence of a person near the information processing apparatus.
